(19) United States
(12) Patent Application Publication
(10) Pub. No.: US 2024/0406493 A1
(43) Pub. Date: Dec. 5, 2024

(54) METHOD AND SYSTEM FOR REALIZING FAST CHANNEL CHANGE FEATURE WITH ANDROID

(71) Applicant: ARRIS ENTERPRISES LLC, Horsham, PA (US)

(72) Inventors: Hongbin ZHAO, Shanghai (CN); Kanaka LAKSHMI, Bangalore (IN); Ramesh NARAYANASWAMY, Bangalore (IN)

(73) Assignee: ARRIS ENTERPRISES LLC, Horsham, PA (US)

(21) Appl. No.: 18/698,838

(22) PCT Filed: Oct. 28, 2021
(86) PCT No.: PCT/CN2021/127035

§ 371 Date: Apr. 5, 2024

(51) Int. Cl. H04N 21/438; H04N 21/422

(52) U.S. Cl. CPC H04N 21/4384; H04N 21/42209

(57) ABSTRACT

A method, a non-transitory computer readable medium, and set-top box with Android with fast channel change on a set-top box with Android are disclosed. The method includes: playing, on the set-top box, a first channel with android.media.tv.tvView.tune; and prefetching and dropping, from a memory of the set-top box, one or more additional channels with an appPrivateCommand with bundle parameters.

### TECHNICAL FIELD

The present disclosure generally relates to a method and system for realizing a fast channel change feature on a set-top box with Android and similar platforms.

### BACKGROUND

Cable service providers, which are also referred to as Multiple System Operators (“MSO”), or any communication or content distribution business that operates through a cable network, renders its services to its subscribers. The services can include, but are not limited to, different subscription plans for broadband Internet access and telephony. In order to consume these services, subscribers connect to a private network owned (or co-owned or rented) by the broadband cable operator which is implemented according to the Data Over Cable Service Interface Specification (DOCSIS) standard. Subscribers connect their computers, routers, voice-over-IP telephones and other devices to this network through the network terminals, for example, cable modems (CM) or network gateways.

To provide television and data services, a MSO typically uses a Cable Modem Termination System (“CMTS”) for the data services and a quadrature amplitude modulation (“QAM”) multiplexer for downstream broadcast television, narrow cast and video-on-demand (VOD) traffic signals. These devices may be located at one or more hubs, which are typically connected to a head end via a network according to a networking protocol, such as Ethernet or SONET. A residential cable customer is typically connected to the CMTS and hub via a cable modem and a wireless router that may be combined in a single box which is called a gateway. In order to view, for example, video content that is transmitted through the cable modem or gateway, residential customers connect, for example, their televisions to a customer-premise equipment or customer-provided equipment (CPE), for example, to a set-top box (STB) or smart media device (SMD).

The set-top box or smart media device can be used by the subscriber to access a variety of multimedia services, including but not limited to live or linear television, digital video recorder (DVR) content, video-on-demand (VOD) content, over-the-top (OTT) content, and others. For example, set-top boxes usually play user selected content, for example, either live or with a digital video recorder (DVR). In addition, content can be accessed by remote controllers and/or via a voice or speech detection application system.

Android as a platform that started off in mobile devices and due to ease of use and user interface (UI) capabilities, is getting popular for other devices such as set-top boxes (STBs) as well. However, Android has limited capabilities when it comes to handling traditional broadcast content such as Motion Picture Experts Group-Transport Stream (MPEG-TS) content delivered over Digital Video Broadcast (DVB) and American Television Standards Committee (ATSC). For this reason, it is customary to pair Android with another platform that is better at handling media content as mentioned above.

It would be desirable to have a method and system for realizing fast channel changes to improve user experience with set-top boxes by minimizing the channel change time.

### SUMMARY

In accordance with an exemplary embodiment, a method and system for realizing fast channel change using an Android platform is described. While the system and method are illustrated for a broadcast media with input in MPEG-TS format, the method and system as disclosed herein can be applicable for other content formats.

In accordance with an aspect, a method for channel change on a set-top box with Android, the method comprising: playing, on the set-top box, a first channel with android.media.tv.tvView.tune; and prefetching and dropping, from a memory of the set-top box, one or more additional channels with an appPrivateCommand with bundle parameters.

In accordance with an another aspect, a non-transitory computer readable medium storing computer readable program code that, when executed by a processor, causes the processor to channel a change on a set-top box with Android, the program code comprising instructions for: playing, on the set-top box, a first channel with android.media.tv.tvView.tune; and prefetching and dropping, from a memory of the set-top box, one or more additional channels with an appPrivateCommand with bundle parameters.

In accordance with a further aspect, a set-top box with Android, the set-top box comprising: a set-top box platform, the set-top platform including set-top box middleware and a set-top box platform driver interface; and an Android service, the Android service including an Android TV manager and a TV provider, the Android TV manager and the TV provider comprising a TV Input Framework configured to: play, on the set-top box, a first channel with android.media.tv.tvView.tune; and prefetch and drop, from a memory of the set-top box, one or more additional channels with an appPrivateCommand with bundle parameters.

### BRIEF DESCRIPTION OF THE DRAWINGS

FIG. 1 is an illustration of an exemplary network environment for a method and system for realizing a fast channel change feature with Android in accordance with an exemplary embodiment.

FIG. 2 is an illustration of integrating a set-top box platform with a television input framework (TIF) in accordance with an exemplary embodiment.

FIG. 3 is an illustration of different stages in channel change in accordance with an exemplary embodiment.

FIGS. 4A and 4B are an illustration of an algorithm for frequent channel change for an Android platform in accordance with an exemplary embodiment.

FIG. 5 is a flowchart illustrating a method for a fast channel change feature with an Android in accordance with an exemplary embodiment.

FIG. 6 is an exemplary hardware architecture for an embodiment of a communication device in accordance with an exemplary embodiment.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. In some instances, well known methods and structures have not been described in detail so as not to unnecessarily obscure the embodiments.

System for Realizing Fast Channel Change Feature with Android

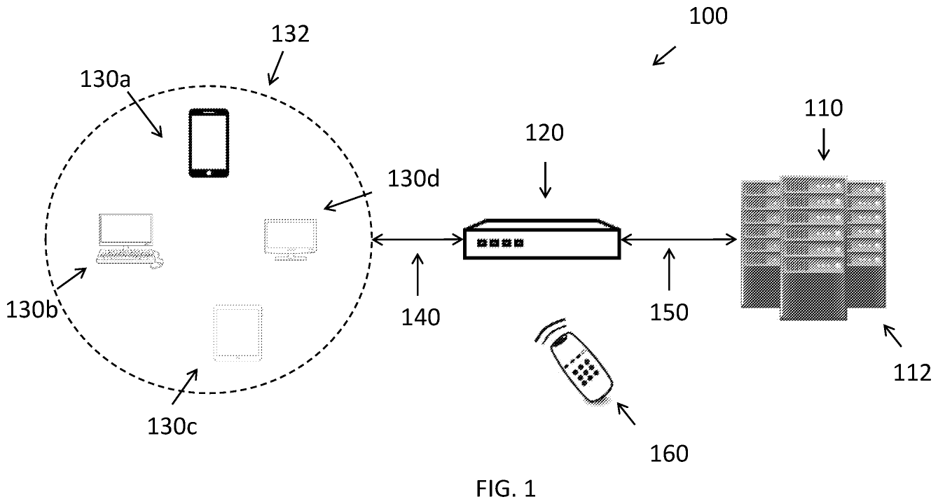

FIG. 1 depicts a block diagram of a high-level system architecture for a set-top box 120 with a fast channel change feature with Android in accordance with an exemplary embodiment. The architecture may be embodied in a system 100, which includes one or more servers 110, for example, of a cable service provider 112, a customer-premise equipment or customer-provided equipment (CPE) in the form of a set-top box or smart media device 120, and a plurality of devices or clients 130a, 130b, 130c, 130d.

In accordance with an exemplary embodiment, the customer-premise equipment or customer-provided equipment (CPE) in the form of a set-top box (STB) or smart media device (SMD) 120 may have a dedicated input device 160, for example, a remote controller 160 paired with the set top box 120. In general, the remote controller 160 wirelessly communicates with the set top box 120 through infrared signals or other wireless technology. A user may send a control signal to the set-top box 120 by selecting and pressing a button on the remote controller 160 to, for example, control the set-top box 120 to start playing of a selected video, pause the playing of a current video, switch channels, enter a standby state, navigate in an electronic program guide and select a program, and select a specific operation in a dialog box that pops up on a TV screen, etc.

Although the user uses the remote controller 160 to control the operation of the set-top box 120, the user may use a mobile device such as a mobile phone or a tablet computer to control the operation of the set-top box 120. In such an embodiment, the user may control the set-top box 120 by operating virtual keys displayed on the screen of the mobile device. The mobile device may communicate with the set-top box 120 through, for example, Bluetooth, WiFi, or other wireless communication protocols.

In accordance with an exemplary embodiment, the set-top box 120 includes an Android platform with a television input framework. In embodiments, the set-top box 120 can provide, for example, video and/or data services to the plurality of devices or clients 130a, 130b, 130c, 130d. The set-top box 120 may communicate with the plurality of devices 130a, 130b, 130c, 130d over a local network 132 (for example, a local area network (LAN), a wireless local area network (WLAN), a personal area network (PAN), etc.) and/or wired, connected to a modem, and may communicate with an upstream wide area network (WAN) through a connection 150 to the one or more servers 110, for example, of the cable service provider 112. The one or more servers 110 can provide high-bandwidth data transfer, for example, cable television and broadband Internet access via, for example, the connection 150. The one or more servers 110 of the cable service provider 112 can be configured to deliver services, for example, cable television and/or broadband Internet.

In accordance with an exemplary embodiment, the set-top box 120 and the plurality of devices 130a, 130b, 130c, 130d can be configured to connect via a wireless network, for example, wireless network utilizing an IEEE 802.11 specification, including a smart phone, a smart TV, a computer, a mobile device, a tablet, a router, a home security system, or any other device operable to communicate wirelessly with the set-top box 120. The set-top box 120 may provide access to an external network, such as the Internet, for any devices connected thereto via the area network 132. The area network 132 may be, for instance a local area. In accordance with an exemplary embodiment, the set-top box 120 with a television input framework operable to deliver, for example, data and/or video services from the one or more servers 110 of the cable service provider 112 and/or a wide area network (WAN) to one or more of the plurality of devices 130a, 130b, 130c, 130d.

In accordance with an exemplary embodiment, the set-top box 120 may communicate with the one or more servers 110 over a wired or a wireless connection. A wireless connection between the one or more servers 110 of the cable service provider 112 and the set-top box 120 may be established through a protected setup sequence (for example, Wi-Fi protected setup (WPS)). The protected setup sequence may include the steps of scanning multiple wireless channels for an available access point, exchanging one or more messages between a station and access point, exchanging key messages (for example, pre-shared key (PSK)) between the station and access point, and installing a key (for example, PSK) at the station.

Android was originally designed as a platform for mobile devices with some capability for playing back media content. The media content capability is oriented towards playing back content from streaming or storage sources. The support for playing back broadcast content such as Quadrature Amplitude Modulation (QAM) can be used in American Television Standards Committee (ATSC), Digital Video Broadcast (DVB) through Cable, Satellite etc. is not available with Android, and which is the objective of most of the set-top boxes (STBs). Therefore, set-top box (STB) software platforms are integrated with Android to handle playback of broadcast content while Android are configured to handle the user interface (UI) and application platforms.

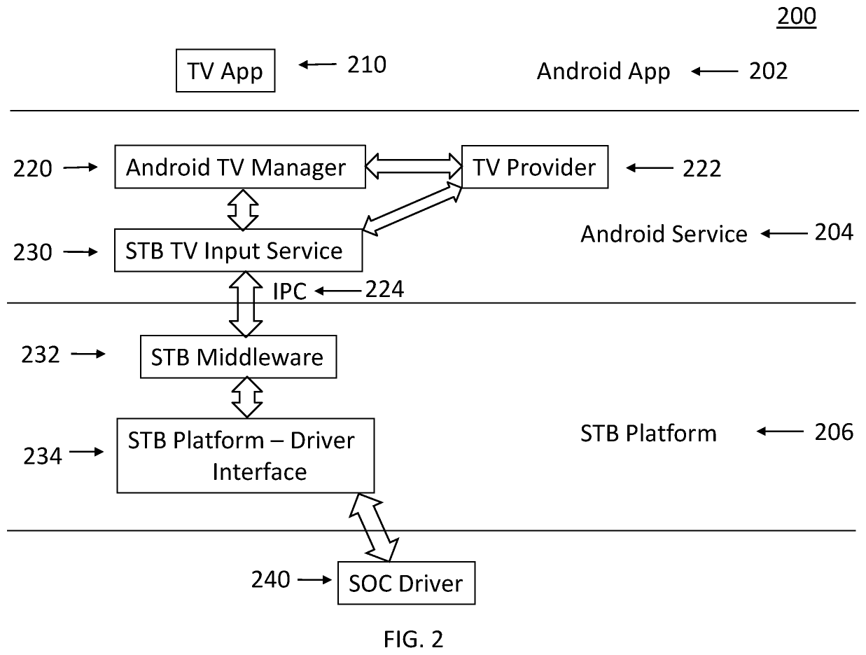

FIG. 2 is an illustration of integrating a set-top box platform 206 with a television input framework (TIF) for Android 204 for realizing fast channel change in accordance with an exemplary embodiment. As shown in FIG. 2, the integration of the set-top box platform 206 with the Android service 204 via an Android application 202 can include an Android TV manager 220, which can access the set-top platform functionalities of the set-top box platform 206 through an inter process communication (IPC) 224 as abstracted by a STB TV Input Service 230. The TV input service 230 being configured to controls and presents channel content on a TV. The integration can be performed using an Android TV Manager 220, for example, a standard Android TV Manager, which interfaces, with the STB TV input service 230 to make use of the functionalities provided by STB Platform 206 software. The STP platform, for example, can include the STB middleware 232 and STB Platform-driver interface 234.

In accordance with an exemplary embodiment, the system 200 can include a third-party television application provider (TV App) 210, which can provide live television (TV) content to the set-top box 200. The Android TV Input Framework (TIF) can include an Android TV manager 220 that allows the TV inputs to communicate with an application that handles user interactions, and a TV provider 222. The TV provider 222 providing a database of channels, programs, and associated permissions. In accordance with an exemplary embodiment, the Android TV Input Framework (TIF) is designed to simplify delivery of live content to Android. The Android TIF can provide a standard API for manufacturers to create input modules for controlling Android TV, and enables live TV search and recommendations via metadata published by the TV Input. The STB platform-driver interface 234 can communicate with a SOC driver (system-on-chip driver) 240. The SOC driver 240 can be configured to integrate, for example, a CPU, graphics and memory interfaces, hard-disk and USB connectivity, random-access and read-only memories and secondary storage and/or their controllers on a single circuit die.

In accordance with an exemplary embodiment, set-top boxes (STBs) 120 generally take, for example, more than 1 second to change a channel, for example, from a first channel to a second channel. The first and second channels being part of a plurality of channels in which each of the plurality of channels are configured to receive, for example, a digital signal, which is decoded and displayed on a television. In accordance with an exemplary embodiment, it would be desirable that the set-top box 120 has a fast channel change (FCC) feature that allows users to achieve shorter channel changes, and which can be implemented for a set-top box (STB) with an Android application.

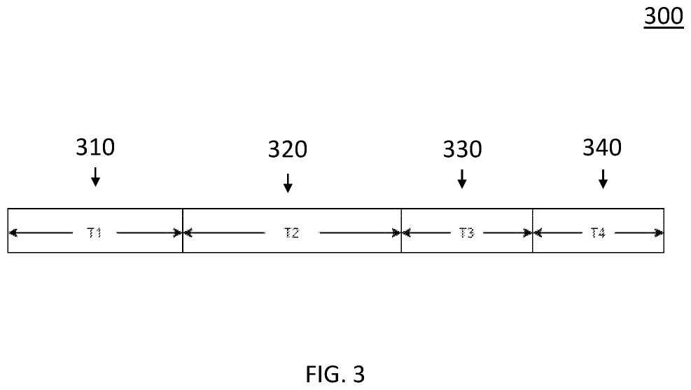

FIG. 3 is an illustration of different stages in channel change in accordance with an exemplary embodiment. In accordance with an exemplary embodiment, channel change response time is the amount of time that a system takes to switch to a newly selected channel. As shown in FIG. 3, the different times can include setting up of a decoding path (T1) 310, basic time stamp management (T2) 320, a wait time for random access point (RAP) (T3) 330, and time for displaying the decoded picture (T4) 340.

In accordance with an exemplary embodiment, the setting up of a decoding path (T1) 310 can include the time required to tear down the decoding path of the currently playing channel and setup the same for the new channel selected. The decoding path can be a pipeline/chain of devices involved in getting the content from the source to the decoding device (for example, a frontend-tuner, a frontend-demodulator, and a demultiplexer). The basic time stamp management 320 is designed to help ensure that the presentation time stamp (PTS) of packets being pushed into the decoder are close to the system time clock (STC) to attain lip-sync levels quickly. The wait time for the random access point (RAP) (T3) 330 can include, for example, a decoder waiting for RAP (Random Access Point) as the video content is generally encoded efficiently by taking advantage of the dependencies of picture frames with respect to the previous or subsequent pictures in the video stream. The time for displaying the decoded picture (T4) 340. In accordance with an exemplary embodiment, by predicting possible channels that will be tuned next, the set-top box 120 can complete some of the stages, for example, stages T1, T2, and T3 before an actual channel change.

In accordance with an exemplary embodiment, it would be desirable to implement fast channel change as system and method that optimizes the time delays introduced due to stages T1 to T3 partly or completely depending on the capabilities of the hardware of the device. The TV input framework (TIF) application programming interfaces (APIs) on the Android platform are designed for tuning to channels and then playback of the content. The TIF APIs are not designed, for example, for preparing to tune to certain content or prefetch content. In addition, the APIs on the TV input framework (TIF) is also designed for efficiency for normal tuning rather than, for example, a fast channel change. Since Android applications uses interface android.media.tv.tvView.tune for tuning to channel, which cannot be used for prefetch as TvView.tune should be called once, the APIs of the TV input framework for Android are not designed for a fast channel change feature. In addition, with the TIF framework (for example, google code), every time when the tune method is called, the available track information will be cleared which results in an empty tracklist being reported to the TV application (TV App) provider.

In accordance with an exemplary embodiment, a system and method are disclosed that tunes an Android application to channel through interface android.media.tv.tvView.tune. However, as set forth above, android.media.tv.tvView.tune cannot be used for prefetch since there can be multiple prefetchs while tuned to channel. For this purpose, sendAppPrivateCommand, which is a method supported in TIF framework, can be used to send private commands between the TV application provider 210 and the STB TV Input service 230. For example, the sendAppPrivateCommand can be used in STB TV Input Service to initiate prefetch and pre-tuning of channels.

In accordance with an exemplary embodiment, the system and method for fast channel change can use the following approach:
1. Use android.media.tv.tvView.tune for playing a channel; and
2. appPrivateCommand with bundle parameters to start prefetch/drop of pretuned channels.

In accordance with an exemplary embodiment, the bundle parameters can comprise of “playchannelUri”, “nextChannelUri” and “droppedChannelUri”. If a channel is to be pretuned, the pretuning of the channel can be done by adding a string “nextChannelUri” in the parameters. If a channel is to be dropped from the pretuned channels, the dropping of the channel can be done by adding a string “droppedChannelUri” in the parameters.

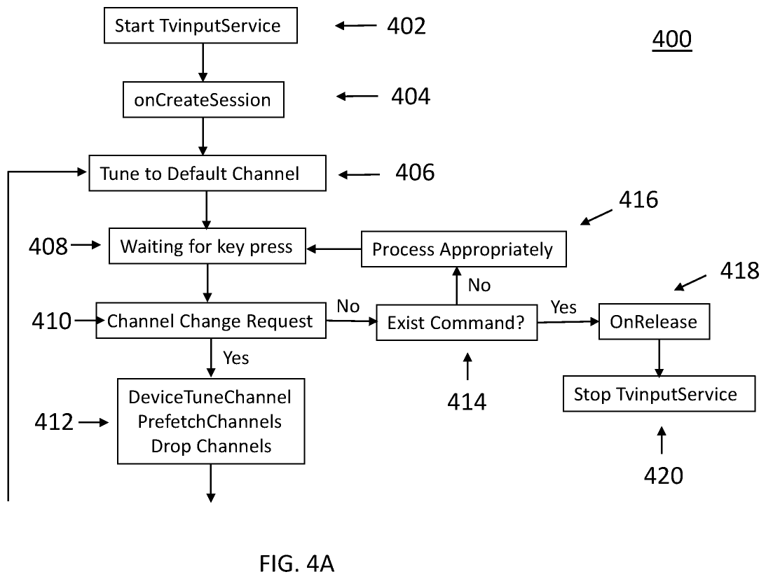

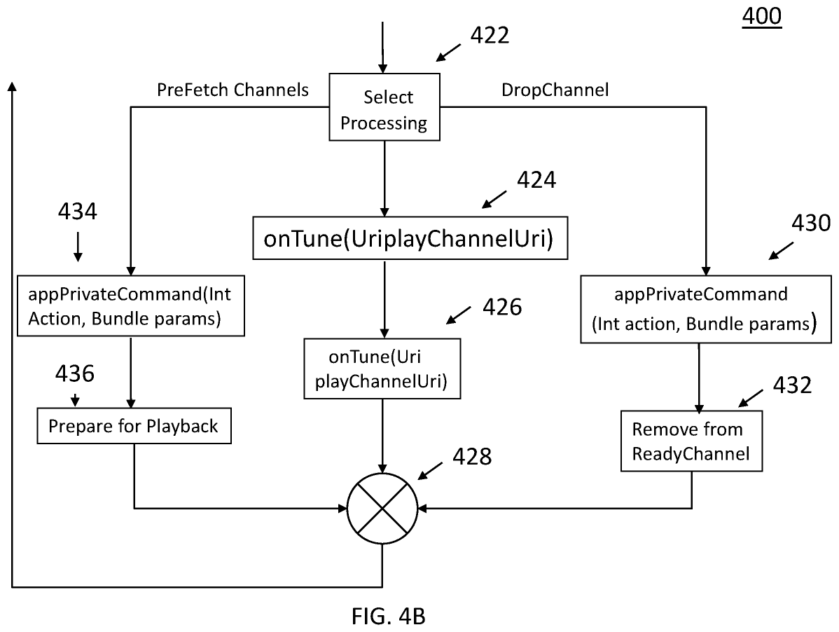

FIGS. 4A and 4B are an illustration of a flowchart or algorithm 400 for frequent channel change for an Android platform in accordance with an exemplary embodiment. In accordance with an exemplary embodiment, based on the current channel selected and the user guide, a method and system is disclose that can compute possible next channels that the user may opt for playing. The process can include creating a list of prefetch channels and dropped channels from the possible next channels that the user may opt for playing. In addition, for dropped channels and prefetch channels, an appPrivateCommand mechanism can be used to communicate the prefetch channel(s) and dropped channel(s) to the STB software platform 206 underneath the Android platform 204. For example, for prefetch channels, the prefetch channels can be made ready for playing when the prefetch channels are selected for play. For example, for tuning and a decoding, a pipe line can be set up for the channel. In addition, a buffer can be adjusted, and the I frame can be ready for playback when the prefetch channel is selected for playback.

As shown in FIGS. 4A and 4B, the process starts with the set-top box TV input Service (Start TvinputService) 402. In step 404, a session in created (i.e., onCreateSession) and the process continues to step 406, in which the session is tuned to default channel. In step 408, the set-top box 120 waits for a key press, for example, a signal from a remote controller that a change from a default channel to another channel of a plurality of channels has been selected for playback. In step 410, the method determines if a channel change request has been received, for example, based on a signal received from a remote controller 160. In step 410, if there is no request for a channel change, the process continues to step 414 for a determination if there is an “Exist Command”, i.e., has the user requested that the session can be closed. If no request for the session to be closed, the process continues to step 416, which keeps the session open (i.e., “Process Appropriately”). Alternatively, if there is an Exist Command, for example, the user has requested that the session be closed (i.e., the television and/or set-top box has been turned off or is in the process of being turned off, the process continues to step 418 (“OnRelease”), which releases the channel change and the process stops the session and proceeds to step 420 (i.e., Stop TvinputService).

In accordance with an exemplary embodiment, if there is a channel change request in step 410, the process continues to step 412 wherein the set-top box will execute a “DeviceTuneChannel”, which can include deriving a list of prefetch channels. For example, in step 412, the list of prefetch channels can include adding one more prefetch channels (“PrefetchChannels), and a dropping of one or more channels (“Drop Channel).

In accordance with an exemplary embodiment, the process continues to step 422 in which a process is selected, for example, a prefetching of one or more channels, a dropping of one or more channels, and playing of a channel (onTune(UriplayChannelUri) 426. The channel play continues to step 426, which the content from the channel is displayed (onTune(UriplayChannelUri). For the prefetch channel process, the process continues to step 434 where the process communicates the prefetch channel to the set-top box software platform with an appPrivateCommand (Int Action, Bundle params) instruction. In step 436, the prefetched channel is prepared for playback. In addition, a channel can be dropped in step 430 using the appPrivateCommand 430. As shown in step 432, a previously prefetched channel can be dropped, i.e., “Remove from ReadyChannel”.

In accordance with an exemplary embodiment, the process continues to step 428 in which the current channel, the one or more prefetch channels, and the one or more dropped channel continue back to step 406 in which the set-top box software platform has been tuned to a default channel, which will be the channel that is currently being played.

Pseudo code for Blocks

In accordance with an exemplary embodiment, the pseudo code for some of the blocks shown in the algorithm in FIGS. 4A and 4B are disclosed.

Block 404-Pseudo code for onCreateSession

```
protected void onCreate(Bundle savedInstanceState) {
// initialize UI
// get access to TvInputService
  mManager = (TvInputManager) getSystemService(Context.TV_INPUT_SERVICE);
// for every TvInput, set up intent and other details
  for (TvInputInfo info : mManager.getTvInputList( )) {
}
// setup callbacks and register handlers
    mTvInfoInfoCallback = new TestTvInputInfoCallback( );
// update channel list
      UpdateChannelList( );
// other required initializations (not connected to FCC)
}
```

Block 412-Pseudo code for deriving list of prefetch channels

```
  deriveChannels( )
  {
    // for this illustration, let us assume that we have two channels in the FCC prefetch
    // channel list. Hence we need to calculate two prefetch channels. Once we derive
    // two prefetch channels, we will also have to drop existing two channels
    // for this let us assume that we have list of the channels in a list
    // to find the channels, we find their index in the list
    // the names are suggestive and hence
      mFccCurrentChannelIndex++;
      int currentIndex = mFccCurrentChannelIndex % mFccChannelList.size( );
      int nextIndex = (mFccCurrentChannelIndex + 1) % mFccChannelList.size( );
      int nextnextIndex = (mFccCurrentChannelIndex + 2) % mFccChannelList.size( );
      int previousIndex = (mFccCurrentChannelIndex − 1) % mFccChannelList. size( );
      int previouspreviousIndex = previousIndex;
      if (currentIndex > 1) {
        previouspreviousIndex = (mFccCurrentChannelIndex − 2) %
  mFccChannelList.size( );
      }
      Uri current_fcc_channel = mFccChannelList.get(currentIndex);
      Uri previous_fcc_channel = mFccChannelList.get(previousIndex);
      Uri previous_previous_fcc_channel = mFccChannelList.get(previouspreviousIndex);
      Uri next_fcc_channel = mFccChannelList.get(nextIndex);
    Uri next_next_fcc_channel = mFccChannelList.get(nextnextIndex);
    // decorate the tune params with previous/next channel uri.
    droppedChannelUri = addPreTuneChannel(params, previous_fcc_channel,
previous_previous_fcc_channel);
    nextChannelUri = addNextTuneChannel(params, next_fcc_channel,
next_next_fcc_channel);
    playChannelUri = addCurrentTuneChannel(params, current_fcc_channel);
}
```

Block 424, 430, 434-Pseudo code for prefetching, playing, and dropping channels

```
fccOperation( )
{
  // Assume that playChannelUri, nextChannelUri and droppedChannelUri are precalculated
  // Refer Block (412) - Pseudo code for deriving list of prefetch channels
  // Examples of these uris are below
  // playChannelUri - “dsd://430b0114250002828102750002.3b.1026.100”
  // nextChannelUri - “dsd://430b0114250002828102750002.3b.1026.200,
  // dsd://430b010847000282a102200004.2.1207.300”
  // droppedChannelUri = “dsd://430b010847000282a102200004.2.1207.400,
  // dsd://430b010847000282a102200004.2.1207.500”
  fccparams.putString(“playChannelUri”, playChannelUri);
  // Now send tune request with params to inputservice.
  mTvView.tune(mCommscopeInfo.getId( ), fccparams);
  // specify the channels to be added FCC list and hence to be primed
  // If channels will be added only if slot(s) is/are available in the FCC channel list
  fccparams.putStringArray(“nextChannelUri”, nextChannelUri);
  // specify the channels to be dropped from FCC list
  // If the specified channel is not part of current FCC list, it will be ignored
  fccparams.putStringArray(“droppedChannelUri”, droppedChannelUri);
  String fccAction = mCommscopeInfo.getId( ) + “.FCC”;
  mTvView.sendAppPrivateCommand(fccAction, fccParam);
}
```

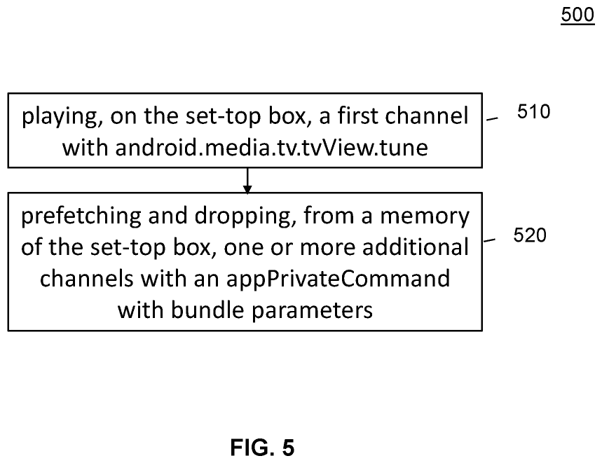

FIG. 5 is a flowchart illustrating a method 500 for a fast channel change feature with an Android in accordance with an exemplary embodiment. As shown in FIG. 5, the method for channel change on a set-top box with Android includes in step 510, playing, on the set-top box, a first channel with android.media.tv.tvView.tune, and in step 520, prefetching and dropping, from a memory of the set-top box, one or more additional channels with an appPrivateCommand with bundle parameters. In accordance with an exemplary embodiment, the bundle parameters can include a play channel uniform resource identifier (“playchannelUri”), a next channel uniform resource identifier (“nextChannelUri”), and a dropped channel uniform resource identifier (“droppedChannelUri”).

In accordance with an exemplary embodiment, the method further includes pretuning, on the set-top box, each of the one or more additional prefetched channels. In addition, each of the one or more additional prefetched channels can be selected based on the channel playing on the set-top box. The method can further include uploading, on the set-top box, a user guide, the user guide providing a list of channels available to the set-top box, and selecting, on the set-top box, the each of the one or more additional prefetched channels based on the channel playing on the set-top box and the user guide, the selected each of the one or more additional prefetched channels being channels adjacent to the channel playing on the set-top box from the list of channels available from the user guide.

In accordance with an exemplary embodiment, the method further includes dropping, from the memory of the set-top box, one or more of the additional prefetched channels upon selection of a second channel for playback on the set-top box. In addition, the method can include pretuning, on the set-top box, each of the one or more additional prefetched channels if one of the one or more additional prefetched channels is selected for playback. The pretuning of each of the one or more prefetched channels can include: setting up of a decode path for each of the one or more prefetched channels; performing a basic time stamp management on each of the one or more prefetched channels; and decoding video content for each of the one or more prefetched channels.

In accordance with an exemplary embodiment, the the first channel is a broadcast media with input in a motion picture experts group-transport stream (MPEG-TS) format.

### Computer System Architecture

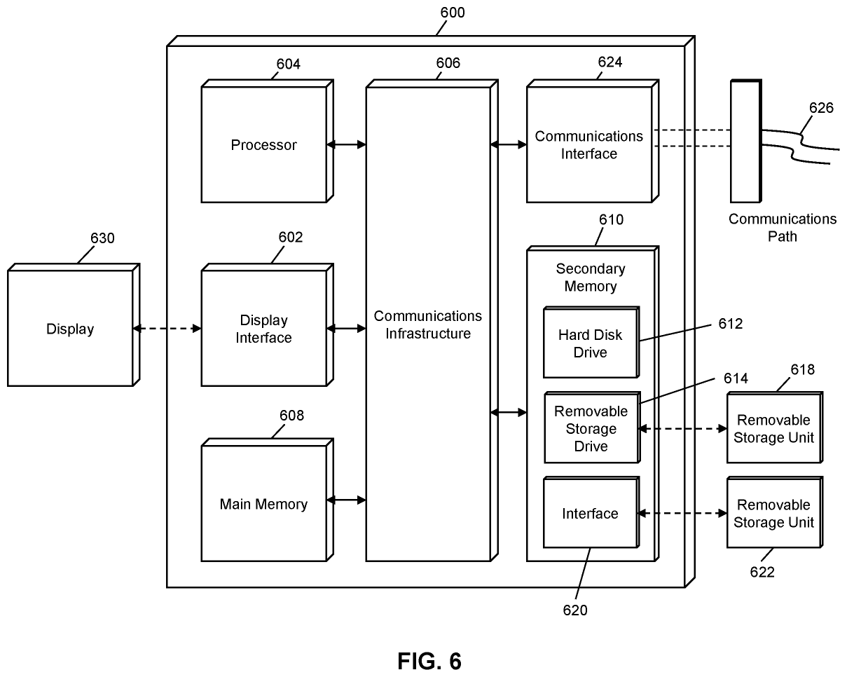

FIG. 6 illustrates a representative computer system 600 in which embodiments of the present disclosure, or portions thereof, may be implemented as computer-readable code executed on a processor of a computer. For example, the one or more servers 110, the CPE 120, and the plurality of devices 130a, 130b, 130c, 130d, of FIG. 1 may be implemented in whole or in part by a computer system 600 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the present disclosure.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this representative computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 1-5, as discussed herein. Accordingly, such computer programs may represent controllers of the computer system 600. Where the present disclosure is implemented using software executed on hardware, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software executed on hardware, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for realizing fast channel change features with Android. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for channel change on a set-top box with Android, the method comprising:
playing, on the set-top box, a first channel with android.media.tv.tvView.tune; and
prefetching and dropping, from a memory of the set-top box, one or more additional channels with an appPrivateCommand with bundle parameters.

2. The method according to claim 1, wherein the bundle parameters include a play channel uniform resource identifier (“playchannelUri”), a next channel uniform resource identifier (“nextChannelUri”), and a dropped channel uniform resource identifier (“droppedChannelUri”).

3. The method according to claim 1, further comprising:
pretuning, on the set-top box, each of the one or more additional prefetched channels.

4. The method according to claim 1, further comprising:
selecting each of the one or more additional prefetched channels based on the channel playing on the set-top box.

5. The method according to claim 4, further comprising:
uploading, on the set-top box, a user guide, the user guide providing a list of channels available to the set-top box; and
selecting, on the set-top box, the each of the one or more additional prefetched channels based on the channel playing on the set-top box and the user guide, the selected each of the one or more additional prefetched channels being channels adjacent to the channel playing on the set-top box from the list of channels available from the user guide.

6. The method according to claim 1, further comprising;
dropping, from the memory of the set-top box, one or more of the additional prefetched channels upon selection of a second channel for playback on the set-top box.

7. The method according to claim 1, further comprising:
pretuning, on the set-top box, each of the one or more additional prefetched channels if one of the one or more additional prefetched channels is selected for playback.

8. The method according to claim 7, wherein the pretuning of each of the one or more prefetched channels comprises:
setting up of a decode path for each of the one or more prefetched channels;
performing a basic time stamp management on each of the one or more prefetched channels; and
decoding video content for each of the one or more prefetched channels.

9. The method according to claim 1, wherein the first channel is a broadcast media with input in a motion picture experts group-transport stream (MPEG-TS) format.

10. A non-transitory computer readable medium storing computer readable program code that, when executed by a processor, causes the processor to channel a change on a set-top box with Android, the program code comprising instructions for:
playing, on the set-top box, a first channel with android.media.tv.tvView.tune; and
prefetching and dropping, from a memory of the set-top box, one or more additional channels with an appPrivateCommand with bundle parameters.

11. The non-transitory computer readable medium according to claim 10, wherein the bundle parameters include a play channel uniform resource identifier (“playchannelUri”), a next channel uniform resource identifier (“nextChannelUri”), and a dropped channel uniform resource identifier (“droppedChannelUri”).

12. The non-transitory computer readable medium according to claim 10, further comprising:
pretuning, on the set-top box, each of the one or more additional prefetched channels; and
selecting the each of the one or more additional prefetched channels based on the channel playing on the set-top box.

13. The non-transitory computer readable medium according to claim 12, further comprising:
uploading, on the set-top box, a user guide, the user guide providing a list of channels available to the set-top box; and
selecting, on the set-top box, the each of the one or more additional prefetched channels based on the channel playing on the set-top box and the user guide, the selected each of the one or more additional prefetched channels being channels adjacent to the channel playing on the set-top box from the list of channels available from the user guide.

14. The non-transitory computer readable medium according to claim 10, further comprising;
dropping, from the memory of the set-top box, one or more of the additional prefetched channels upon selection of a second channel for playback on the set-top box.

15. The non-transitory computer readable medium according to claim 10, further comprising:
pretuning, on the set-top box, each of the one or more additional prefetched channels if one of the one or more additional prefetched channels is selected for playback; and
wherein the pretuning of each of the one or more prefetched channels comprises:
setting up of a decode path for each of the one or more prefetched channels;
performing a basic time stamp management on each of the one or more prefetched channels; and
decoding video content for each of the one or more prefetched channels.

16. A set-top box with Android, the set-top box comprising:
a set-top box platform, the set-top platform including set-top box middleware and a set-top box platform driver interface; and
an Android service, the Android service including an Android TV manager and a TV provider, the Android TV manager and the TV provider comprising a TV Input Framework configured to:
play, on the set-top box, a first channel with android.media.tv.tvView.tune; and
prefetch and drop, from a memory of the set-top box, one or more additional channels with an appPrivateCommand with bundle parameters.

17. The set-top box according to claim 16, wherein the bundle parameters include a play channel uniform resource identifier (“playchannelUri”), a next channel uniform resource identifier (“nextChannelUri”), and a dropped channel uniform resource identifier (“droppedChannelUri”).

18. The set-top box according to claim 16, wherein the TV Input Framework is further configured to:
pretune, on the set-top box, each of the one or more additional prefetched channels; and
select the each of the one or more additional prefetched channels based on the channel playing on the set-top box.

19. The set-top box according to claim 18, wherein the TV Input Framework is further configured to:
upload, on the set-top box, a user guide, the user guide providing a list of channels available to the set-top box; and
select, on the set-top box, the each of the one or more additional prefetched channels based on the channel playing on the set-top box and the user guide, the selected each of the one or more additional prefetched channels being channels adjacent to the channel playing on the set-top box from the list of channels available from the user guide.

20. The set-top box according to claim 16, wherein the TV Input Framework is further configured to:
drop, from the memory of the set-top box, one or more of the additional prefetched channels upon selection of a second channel for playback on the set-top box;
pretune, on the set-top box, each of the one or more additional prefetched channels if one of the one or more additional prefetched channels is selected for playback; and
wherein the pretune of each of the one or more prefetched channels comprises:
setting up of a decode path for each of the one or more prefetched channels;
performing a basic time stamp management on each of the one or more prefetched channels; and
decoding video content for each of the one or more prefetched channels.
